(19) United States
(12) Patent Application Publication
(10) Pub. No.: US 2024/0093044 A1
(43) Pub. Date: Mar. 21, 2024

(54) TINTED TRANSPARENT SIDE STRIPE POWDER COATING

(71) Applicant: SWIMC LLC, Cleveland, OH (US)

(72) Inventors: Raffaele Martinoni, Wolfhausen (CH); Rolf Frischkopf, Wetzikon (CH)

(21) Appl. No.: 18/255,404

(22) PCT Filed: Dec. 9, 2021
(86) PCT No.: PCT/US2021/062570

§ 371 Date: Jun. 1, 2023

Related U.S. Application Data
(60) Provisional application No. 63/123,395, filed on Dec. 9, 2020.

(51) Int. Cl. C09D 7/61; C09D 5/03; C09D 167/02

(52) U.S. Cl. CPC C09D 7/61; C09D 5/035; C09D 167/02

(57) ABSTRACT

A coating composition including: about 50 wt % to 99 wt % of at least one thermoplastic polyester resin having a weight-average molecular weight (Mw) of about 15,000 to about 60,000; and about 0.5 wt % to about 5 wt % of at least one metal-containing oxide chosen from iron oxides, zinc oxides, and mixtures and combinations thereof; and wherein the coating composition is meltable to form a coating on at least one portion of a substrate formed into a side seam of a container.

This application claims the benefit of U.S. Application No. 63/123,395, filed Dec. 9, 2020, the contents of which are hereby incorporated by reference in their entirety.

### BACKGROUND

The interiors of metal food and beverage containers can be coated with a thin polymer coating to protect the interior metal surface from corrosion caused by the can contents. Some metal containers, such as, for example, three-piece food and beverage cans, have a sidewall formed from a rectangular sheet that has been seamed together on two edges (typically via a weld) to form a cylinder. The weld or side seam of the metal container may be coated with an additional coating to further enhance corrosion protection. Side seam coatings generally should exhibit sufficient adhesion (e.g., both to any exposed metal substrate or weld, as well as the adjacent interior can coating) and flexibility when used to protect the side seam or weld seam of a three-piece metal can, for example.

In some cases, clear powder coating compositions can have inferior adhesion to a side seam of a metal can, and can also have lower pack resistance, particularly if the food in the container includes sulfur (for example, fish or meat). To improve side seam coating opacity with a thinner coating, and enhance clarity in quality control procedures, powder coating compositions can include a hiding pigment such as, for example, titanium dioxide (TiO₂).

To reduce environmental impact and enhance consumer safety, side seam coatings with smaller amounts of TiO₂, or that are substantially free of TiO₂, are needed.

### SUMMARY

In general, the present disclosure is directed to powder coating compositions that can be applied on weld or a side seam of a metal food or beverage container such as, for example, a three-piece metal can, to form a side seam coating thereon. Typically, such side seam coating is on the interior of the can, meaning the side seam should preferably be compatible with a wide variety of interior can coatings and resistant to a wide variety of food products having varied chemical features (e.g., acidic, alkaline, fatty, high in protein, high in sugars, etc.). In preferred embodiments, the powder coating composition includes at least one polyester and at least one metal-containing oxide preferably chosen from iron oxides, zinc oxides, and mixtures and combinations thereof. The metal oxides in the side seam coatings formed from the powder coating composition preferably react with sulfur-containing compounds in the food or beverage product packaged in the container that may migrate into the coating, which can prevent the sulfur-containing compounds from attacking the underlying metal surface of the container. In various embodiments, the powder coating compositions of the present disclosure form side seam coatings that have decreased sulfur staining, improved pack resistance, and improved side seam adhesion.

In one aspect, the present disclosure is directed a coating composition including: about 50 wt % to 99 wt % of at least one thermoplastic polyester resin having a weight-average molecular weight (Mw) of about 15,000 to about 60,000; and about 0.5 wt % to about 5 wt % of at least one metal-containing oxide chosen from iron oxides, zinc oxides, and mixtures and combinations thereof; wherein the coating composition is meltable to form a coating on at least one portion of a substrate formed into a side seam of a container, typically a welded side seam.

In another aspect, the present disclosure is directed to a method for forming a coating on a side seam of a metal container. The method includes: applying to a substrate a coating composition including: about 50 wt % to 99 wt % of at least one thermoplastic polyester resin having a weight-average molecular weight (Mw) of about 15,000 to about 60,000; and about 0.5 wt % to about 5 wt % of a metal-containing oxide reactable with sulfide-containing compounds; and melting the coating composition to form a coating on at least one portion of the substrate, wherein the substrate is a side seam of the metal container or is formed into a side seam of a metal container.

In another aspect, the present disclosure is directed to a metal container including a side seam, and a coating formed on the side seam. The coating has an average coating thickness of about 40 microns to about 100 microns, and is formed from a coating composition including: about 50 wt % to 99 wt % of at least one thermoplastic polyester resin having a weight-average molecular weight (Mw) of about 15,000 to about 60,000; and about 0.5 wt % to about 5 wt % of a metal-containing oxide reactable with sulfide containing compounds.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### SELECTED DEFINITIONS

Unless otherwise specified, the following terms as used herein have the meanings provided below.

The term “bisphenol” refers to a polyhydric polyphenol having two phenylene groups that each includes six-carbon rings and a hydroxyl group attached to a carbon atom of the ring, wherein the rings of the two phenylene groups do not share any atoms in common. By way of example, hydroquinone, resorcinol, catechol, and the like are not bisphenols because these phenol compounds only include one phenylene ring.

The term “component” refers to any compound that includes a particular feature or structure. Examples of components include compounds, monomers, oligomers, polymers, and organic groups contained there.

The term “substantially free” of a particular component means that the compositions, or coatings formed therefrom, of the present disclosure contain less than 1,000 parts per million (ppm) of the recited component, if any. The term “essentially free” of a particular component means that the compositions, or coatings formed therefrom, of the present disclosure contain less than 100 parts per million (ppm) of the recited component, if any. The term “essentially completely free” of a particular component means that the compositions, or coatings formed therefrom, of the present disclosure contain less than 10 parts per million (ppm) of the recited component, if any. The term “completely free” of a particular component means the compositions, or coatings formed therefrom, of the present disclosure contain less than 20 parts per billion (ppb) of the recited component, if any.

The term “thermoplastic” refers to a material that melts and changes shape when sufficiently heated and hardens when sufficiently cooled. Such materials are typically capable of undergoing repeated melting and hardening without exhibiting appreciable chemical change. In contrast, a “thermoset” refers to a material that is crosslinked and does not “melt.”

Unless otherwise indicated, a reference to a “(meth)acrylate” compound (where “meth” is bracketed) is meant to include both acrylate and methacrylate compounds.

The term “polycarboxylic acid” includes both polycarboxylic acids and anhydrides thereof.

The term “optimal,” as used herein, means best or most favorable with reference to one or more properties of a coating, relative to a conventional coating. Therefore, optimal adhesion means that the coating has the most favorable adhesion to the substrate relative to a conventional coating or other coating used for comparison, i.e. a level of adhesion that would be acceptable within the industry. As used herein, the term refers to the level of adhesion demonstrated by a coating such that the coating can resist mechanical stress and deformation during fabrication and use without losing adhesion and thereby provide full protection to the underlying substrate.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives. The phrases “at least one of” and “comprises at least one of” followed by a list refers to any of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### BRIEF DESCRIPTION OF DRAWINGS

FIG. 1 includes plots of cumulative distribution vs. particle size and density distribution vs. particle size for the powder coating composition of Example 1.

FIG. 2A is a photograph of a tinted coating made from the powder coating composition of Example 3.

FIG. 2B is a photograph of the coating of FIG. 2A following retort in a sulfuric acid solution (Example 3).

Like symbols in the drawings indicate like elements.

### DETAILED DESCRIPTION

In one aspect, the present disclosure is directed to a powder coating composition for forming coatings on substrates, such as metal substrates used to form three-piece food and beverage cans. The present disclosure is also directed to containers having weld seam or side seam coatings formed from the powder coating compositions described herein, and related methods of forming and applying the composition.

The powder coating composition includes at least one first polyester and at least one metal-containing oxide chosen from iron oxides, zinc oxides, cadmium oxides, and mixtures and combinations thereof. The metal oxides in the side seam coatings formed from the powder coating composition react with sulfur-containing compounds in the food or beverage in the container, which can reduce sulfur staining, improve pack resistance, and improve side seam adhesion.

The powder coating composition includes at least one first polyester. The at least one first polyester described herein may have a weight-average molecular weight (M_{w}) of about 15,000 to about 60,000, or about 18,000 to about 50,000, about 25,000 to about 40,000. In some examples, the M_{w} may be determined via gel permeation chromatography (GPC) using polystyrene standards. In some embodiments, the first polyester is a semi-crystalline polyester having a glass transition temperature (T_{g}) of about −10° C. to about 45° C., or about 10° C. to about 40° C., or about 15° C. to about 35° C. In some embodiments, the first polyester may have a melting temperature of about 120° C. to about 200° C., or about 140° C. to about 180° C. As used herein, the “glass transition temperature” and the “melting temperature” may each be determined using differential scanning calorimetry (DSC) (e.g., using a standard DSC heat-cool-heat method with a 20° C. per minute temperature change rate).

In some embodiments, the at least one first polyester resin described herein may be included in a blend including two or more polyesters. The second polyesters present in the blend may have any suitable molecular weight, any suitable melt viscosity, and any suitable T_{g}. In some examples, which are not intended to be limiting, the second polyesters may include amorphous thermoplastic polyester resins with a Tg that is generally higher than the T_{g} of the at least one first polyester, for example, between about 20° C. and about 70° C. In some embodiments, the M_{w} of the second polyester is higher than that of the at least one first polyester by at least about 15,000, and more preferably by at least about 20,000, and the M_{w} of the second polyester is typically about 40,000 to about 70,000. A detailed description of one non-limiting example of a polyester blend used in a powder coating composition is set forth in WO2014065858.

In some embodiments, the first polyester may constitute from about 70% to 100% by weight of the polyester blend, and more preferably from about 85% to 100% by weight of the polyester blend. In some embodiments, the first polyester may constitute from about 90% to 100% by weight of the polyester blend. In embodiments in which the polyester blend includes the second polyester, the second polyester may constitute from about 1% to about 30% by weight of the polyester blend, and more preferably from about 5% to about 15% by weight of the polyester blend.

In various embodiments, the first and the second polyesters are present in the powder coating composition in an amount of at least about 50 wt % to about 85 wt %, or about 60 wt % to about 70 wt %, or about 70 wt % to about 85 wt %, based on the total weight of the powder coating composition.

The first and second polyesters described herein may be prepared, for example, by condensing a dicarboxylic acid with a diol (e.g., an aliphatic diol). In some embodiments, the dicarboxylic acid may include terephthalic acid, isophthalic acid, a naphthalene dicarboxylic acid, or mixtures thereof. It is also understood that an esterifiable derivative of a dicarboxylic acid, such as a dimethyl ester or anhydride of a dicarboxylic acid, can be used to prepare the polyesters.

In particular, exemplary dicarboxylic acids used to prepare the polyester may include aliphatic and aromatic dicarboxylic acids, such as, but not limited to, phthalic acid, isophthalic acid, terephthalic acid, 5-tert-butyl isophthalic acid, adipic acid, malonic acid, 2,6-naphthalenedicarboxylic acid, 1,5-naphthalenedicarboxylic acid, hexahydroterephthalic acid, 1,4-cyclohexanedicarboxylic acid, sebacic acid, azeleic acid, succinic acid, glutaric acid, fumaric acid, 2,5-furandicarboxylic acid, and mixtures and esterifiable derivatives thereof. Substituted aliphatic and aromatic dicarboxylic acids, such as halogen or alkyl-substituted dicarboxylic acids, may also be useful.

Non-limiting examples of diols that may be useful in preparing the polyester may include ethylene glycol, diethylene glycol, triethylene glycol, propylene glycol, dipropylene glycol, hexylene glycol, butylene glycol, pentylene glycol, neopentyl glycol, trimethylpropane diol, 1,4-cyclohexanedimethanol, 1,10-decanediol, 2,2-dimethyl-1,3-propanediol, 2,2,4,4-tetramethyl-1,3-cyclobutandiol, tricyclodecanedimethanol, 3,9-bis(1,1-dimethyl-2-hydroxyethyl)-2,4,8,10-tetraoxaspiro[5.5]undecane, a polyethylene or polypropylene glycol having a molecular weight of about 500 or less, and mixtures thereof. A small amount of a triol or polyol, such as, 0 to 3 mole % of diol, can be used to provide partially branched polyesters, as opposed to linear polyesters.

The diol and the dicarboxylic acid, in correct proportions, may be reacted under standard esterification procedures to provide one or more polyesters having the desired molecular weights, glass transition temperatures, molecular weight distributions, branching (if any), crystallinities, and functionality for use in a present powder coating composition. In some embodiments, a transesterification procedure may be used to provide one or more such polyesters.

Examples of useful polymers and copolymers for the polyesters include polyethylene terephthalates (PET), polyethylene terephthalates derived from both terephthalic acid and isophthalic acid (PET-I), polybutylene terephthalates (PBT), polyethylene naphthalates (PEN), and polybutylene naphthalates (PBN), polytrimethylene terephthalate (PTT), polytrimethylene naphthanate (PTN), and copolymers and mixtures thereof. Such polyesters may include any combination of one or more additional co-monomers.

Suitable polymers and copolymers for the first and the second polyester are commercially available under the trade designation DYNAPOL from Evonik Corp. Resource Efficiency GMBH of Marl, Germany. Examples of specific suitable polyesters, which are not intended to be limiting, include DYNAPOL P1500, DYNAPOL EP S 1662, and the like. Additional suitable polymers and copolymers for the first and the second polyester include those available from EMS-Chemie, Domat, Switzerland, under the trade designations GRILTEX, such as GRILTEX D 2343 FG, GRILTEX D 2360 EG, and GRILTEX V79-20.

The power coating composition further includes at least one metal-containing oxide that is preferably capable of reacting with sulfur or sulfur containing compounds commonly found in foods such as meat and fish. In various embodiments, suitable metal-containing oxides include iron oxides, zinc oxides, and mixtures and combinations thereof.

Suitable iron oxides include, but are not limited to, FeOOH, Fe₂O₃, Fe₃O₄, FeO, Fe₂O₃·nH₂O, FeCO₃, Fe₂(CO₃)₂, and mixtures and combinations thereof. Suitable zinc oxides include, but are not limited to ZnO, ZnCO₃, and mixtures and combinations thereof, while suitable cadmium oxides include, but are not limited to, CdOOH, Cd(OH)₂, and mixtures and combinations thereof. Suitable commercially available iron oxides are available under the trade designation BAYFERROX from Lanxess Deutschland GMBH, Köln, DE, such as BAYFERROX 3905, a synthetic iron hydroxide yellow pigment having the general formula α-FeOOH.

The one or more metal-containing oxides are preferably present in the composition in an efficacious amount to suitably protect the underlying metal substrates. In various embodiments, the metal-containing oxides are present in the powder coating composition in an amount of at least about 0.1 wt %, at least about 0.5 wt %, or at least about 1 wt %. In some embodiments, the metal-containing oxides are present in an amount of less than about 5 wt %, less than about 5 wt %, or less than about 3 wt %. In preferred embodiments, the metal-containing oxides are present in the powder coating composition at about 0.1 wt % to about 5 wt %, or about 0.5 wt % to about 4 wt %, or about 1 wt % to about 3 wt %, based on the total weight of the composition.

The metal-containing oxides also pigment the powder coating composition and provide a coating with a color such as gold, yellow, or beige. As noted above, such pigmentation enhances the hiding properties of the coating and also makes possible optical visualization of the coating, which can be useful in quality control procedures.

In some embodiments, the powder coating composition includes at least one additional modifying resin component such as, for example, an epoxy or phenoxy resin, an acrylic resin, a polyolefin resin, and mixtures and combinations thereof. The optional modifying resin does not substantially react with the polyesters during manufacture of the powder coating composition or during the powder coating process. In some embodiments, the modifying resin can improve the barrier properties of the applied coating and the adhesion of the powder coating composition to the metal substrate.

Accordingly, preferably, the powder coating compositions, and preferably, coatings formed therefrom, of the present disclosure are substantially free of each of bisphenol A, bisphenol F, and bisphenol S, structural units derived therefrom, or both; the powder coating compositions, and preferably, coatings formed therefrom, of the present disclosure are essentially free of each of bisphenol A, bisphenol F, and bisphenol S, structural units derived therefrom, or both; the powder coating compositions, and preferably, coatings formed therefrom, of the present disclosure are essentially completely free of each of bisphenol A, bisphenol F, and bisphenol S, structural units derived therefrom, or both; or the powder coating compositions, and preferably, coatings formed therefrom, of the present disclosure are completely free of each of bisphenol A, bisphenol F, and bisphenol S, structural units derived therefrom, or both.

More preferably, the metal packaging powder coating compositions, and preferably coatings formed therefrom, of the present disclosure are substantially free of all bisphenol compounds, structural units derived therefrom, or both; the powder coating compositions, and preferably coatings formed therefrom, of the present disclosure are essentially free of all bisphenol compounds, structural units derived therefrom, or both; the powder coating compositions, and preferably coatings formed therefrom, of the present disclosure are essentially completely free of all bisphenol compounds, structural units derived therefrom, or both; or the powder coating compositions, and preferably coatings formed therefrom, of the present disclosure are completely free of all bisphenol compounds, structural units derived therefrom, or both.

Preferred epoxy and phenoxy resins include BPA-free and BADGE-free epoxy and phenoxy resins based on the aromatic diepoxides (e.g., diglycidyl ethers) described in U.S. Pat. Nos. 9,409,219, 10,793,742, 11,053,409 and U.S. Publ. No. 2020/0347264 and 2019/0345359, with the diepoxide of 4,4′-methylenebis(2,6-dimethylphenol) being one such example of an aromatic diepoxide. In some embodiments, epoxy and phenoxy resins based on non-aromatic diepoxides such as, for example, those described in U.S. Publ. No. 2013/0280455 and Intl. Publ. No. WO2021105970 may be used. An epoxy resin can be used in its commercially available form, or can be prepared by advancing a low molecular weight epoxy compound by standard methods well known to those skilled in the art. The epoxy-containing compounds and/or phenoxy-containing compounds also preferably have a fine particle size distribution as discussed above for the blend of one or more polyesters.

In some examples, suitable acrylic resins have a M_{w} of about 15,000 to about 100,000, and preferably about 20,000 to about 80,000. Acrylic resins include, but are not limited to, homopolymers and copolymers of acrylic acid, methacrylic acid, esters of acrylic acid, esters of methacrylic acid, acrylamides, and methacrylamides.

In some examples, suitable polyolefin resins have a M_{w} of about 15,000 to about 1,000,000, and preferably about 25,000, and include, but are not limited to, homopolymers and copolymers of ethylene, propylene, ethylenepropylene blends, 1-butene, and 1-pentene. In some examples, the polyolefin also can contain functionalized olefins, such as an olefin functionalized with hydroxy or carboxy groups.

In one example embodiment, the additional modifying resin component is a highly functional low molecular weight polymer that includes at least one monomer unit derived from a glycidyl ester of an α,β-unsaturated acid or anhydride thereof (.e.g., glycidyl methacrylate). In another aspect, the resin component is a copolymer including a first monomeric unit derived from a glycidyl ester of an α,β-unsaturated acid or anhydride thereof and a second monomeric unit derived from an alkyl (meth)acrylate.

Examples of suitable compounds suitable for forming the additional resin component include carboxylic acids such as acrylic acid, methacrylic acid, ethacrylic acid, alpha-chloroacrylic acid, alpha-cyanoacrylic acid, beta-methylacrylic acid (crotonic acid), alpha-phenylacrylic acid, beta-acryloxypropionic acid, sorbic acid, alpha-chlorosorbic acid, angelic acid, cinnamic acid, p-chlorocinnamic acid, beta-stearylacrylic acid, itaconic acid, citraconic acid, mesaconic acid, glutaconic acid, aconitic acid, maleic acid, fumaric acid, tricarboxyethylene, maleic anhydride, and mixtures thereof. Specific examples of monomers containing a glycidyl group include glycidyl (meth)acrylate (i.e., glycidyl methacrylate and glycidyl acrylate), mono- and di-glycidyl itaconate, mono- and di-glycidyl maleate, and mono- and di-glycidyl formate. It also is envisioned that allyl glycidyl ether and vinyl glycidyl ether can be used as the monomer. In some embodiments, a preferred epoxy functionalized monomer is glycidyl (meth)acrylate.

In one embodiment, the additional resin component included in the powder coating composition described herein is a polymer derived from glycidyl methacrylate (GMA), or a copolymer of GMA with ethyl methacrylate (EMA) or other (meth)acrylate monomers, or mixtures and combinations thereof. Exemplary resin components include GMA-containing polymers and/or copolymers including but not limited to those commercially available from Estron Chemical, Calvert City, KY. Particularly useful compounds are commercially available from Estron Chemical under the trade designation GMA such as, for example, GMA-302.

In various embodiments, the powder coating composition includes 0 wt % to about 25 wt % of the additional modifying resin, or about 1 wt % to about 5 wt %, or about 2 wt % to about 3 wt %, or about 2 wt % to about 20 wt %, or about 8 wt % to about 15 wt %.

In some embodiments, the powder coating compositions described herein may include one or more optional additives. Examples of suitable additives for the powder coating composition include colorants, inorganic fillers, surfactants, flow control agents, heat stabilizers, anti-corrosion agents, antioxidants, adhesion promoters, light stabilizers, and combinations thereof.

For example, in some embodiments, the powder coating composition may include a colorant, such as a pigment or dye. Examples of suitable colorants for use in the powder coating composition include inorganic pigments such as barium sulfate, titanium dioxide and other metal oxides in addition to the metal-containing oxides described above, as well as organic dyes and pigments.

The colorant may constitute, e.g., from about 1% to about 50% by weight of the powder coating composition, more preferably from about 10% to about 30% by weight, and even more preferably from about 15% to about 20% by weight. The use of a higher colorant concentration may be advantageous to achieve good coverage with thinner coatings.

In various embodiments, the amount of titanium dioxide (TiO₂) pigment present in the powder coating composition is no more than 1 wt %, or no more than 0.5 wt %, or no more than 0.1 wt %, based on the total weight of the coating composition. In some embodiments, the powder coating composition is substantially free of TiO₂, or essentially free of TiO₂, or completely free of TiO₂.

Examples of inorganic fillers used in the powder coating composition of the present invention include, but are not limited to, clay, mica, aluminum silicate, fumed silica, magnesium oxide, barium oxide, barium sulfate, calcium sulfate, calcium oxide, aluminum oxide, magnesium aluminum oxide, and mixtures and combinations thereof. If present, the one or more inorganic fillers may constitute, e.g., from about 0.1% to about 20% by weight of the powder coating composition, more preferably from about 1% to about 15% by weight, and even more preferably from about 2% to about 10% by weight.

An exemplary flow control agent for use in the powder coating composition is a polyacrylate commercially available under the tradename PERENOL from Henkel Corporation, Rocky Hill, CN. Additionally, useful polyacrylate flow control agents are commercially available under the tradename ACRYLON MFP from Protex France, and those commercially available from BYK-Chemie GmbH, Germany. Numerous other compounds and other acrylic resins known to persons skilled in the art also can be used as a flow control agent. The flow control agents may constitute, e.g., from about 0.1% wt % to about 5 wt % of the powder coating composition, and more preferably from about 0.2 wt % to about 2 wt %, or about 1 wt % to about 2 wt %. The flow control agent assists in achieving a uniform thin film for the applied onto the inner surface of a container, and may further assist in reducing lumping and dust issues that may otherwise occur with fine powder particles.

Examples of suitable surfactants for use in the powder coating composition include wetting agents, emulsifying agents, suspending agents, dispersing agents, and combinations thereof. Examples of suitable surfactants for use in the coating composition include non-ionic and anionic surfactants (e.g., waxes). The surfactants may constitute from about 0.1 wt % to about 10 wt % of the powder coating composition, or from about 0.2 wt % to about 5 wt %.

The powder coating composition of the present disclosure can be prepared by methods well known in the art, such as by individually heating the one or more polyesters, and the other resin additives, along with fillers, colorants, flow control agents, and the like, to a sufficient temperature to melt the polyester and compound the composition, such as in a single screw or double screw extruder, to provide a substantially homogenous blend.

Without being bound by any theory, presently available evidence indicates that the additional resin components could undergo crosslinking at the temperature at which the composition is typically extruded. Accordingly, in an example embodiment, to avoid crosslinking of the resin additive, the extruder is maintained at a temperature of about 125° C. to about 250° C., or about 150° C. to about 220° C.

The resulting blend of polyester and resin component may then be compounded into pellets, crystallized, and milled (e.g., cryogenic milling) to attain the desired fine particle sizes. One or more of the optional additives may then be mixed with the polyester particles, and the resulting composition may be sieved and packaged for subsequent use. Alternatively, one or more of the optional additives may be included in a melt blend including the one or more polyesters.

The powder coating composition described herein preferably has a fine particle size distribution suitable for side seam coating applications. For example, in various embodiments, suitable average particle sizes (D50) for the powder coating composition can be about 40 microns to about 100 microns, or about 50 microns to about 100 microns.

In some embodiments, the powder coating composition has a very small inhalable fraction of particles with average particle sizes (D50) of less than about 10 microns, or less than about 1 micron. In some examples, the inhalable particle fraction in the powder coating composition is 0 wt % to no more than about 10 wt %, or 0 wt % no more than about 1 wt %, or 0 wt % to no more than about 0.1 wt %, based on the total weight of the powder coating composition.

The “D-values”—D50, D90, D95, and D99—are the particle sizes which divide a sample's volume into a specified percentage when the particles are arranged on an ascending particle size basis. For example, for particle size distributions the median is called the D50 (or x50 when following certain ISO guidelines). The D50 is the particle size in microns that splits the distribution with half above and half below this diameter. The Dv50 (or Dv0.5) is the median for a volume distribution. The D90 describes the particle size where ninety percent of the distribution has a smaller particle size and ten percent has a larger particle size. The D95 describes the particle size where ninety five percent of the distribution has a smaller particle size and five percent has a larger particle size. The D99 describes the particle size where ninety nine percent of the distribution has a smaller particle size and one percent has a larger particle size. Unless specified otherwise herein, D50, D90, D95, and D99 refer to Dv50, Dv90, Dv95, and Dv99, respectively.

The D-values specified herein may be determined by laser diffraction particle size analysis using a Beckman Coulter LS 230 Laser Diffraction Particle Size Analyzer or equivalent, calibrated as recommended by the manufacturer.

During use, the powder coating composition may be applied to a metal substrate, such as, without limitation, at a side seam or weld seam of a three-piece can. While the powder coating composition is particularly useful as a weld seam coating, the powder coating composition may also be used for a variety of other coating applications. For example, in some embodiments, the powder coating composition may be applied to assist in forming the lid seal and/or bottom seal of a three-piece container as described in WO 2014065858.

The final powder may then be applied to an article by various techniques including the use of fluid beds and spray applicators. In some examples, an electrostatic spraying process is used, in which a welded cylinder is electrostatically charged, and the particles are sprayed onto the side seam of the welded cylinder by a spray head. The spray head includes a barrier that prevents over spray of powder on other can surfaces. The powder particles emerging from the spray head are attracted to and cling on the designated portion of the side seam of the article. After coating, the article is heated, which causes the powder particles to melt and flow together to coat the article. Optionally, continued or additional heating may be used to cure the coating.

The powder coating composition of the present disclosure can be applied to essentially any metal substrate. Nonlimiting examples of metal substrates include aluminum, tin-free steel, tinplate, steel, zinc-plated steel, zinc alloy-plated steel, lead-plated steel, lead alloy-plated steel, aluminum-plated steel, aluminum alloy-plated steel, stainless steel, and the like.

The coating is optionally cured, and such curing may occur via continued heating, subsequent heating, or residual heat in the substrate. In some embodiments, the powder coating composition described herein is cured by heating to a molten stage followed by solidifying the coating by active or passive cooling leading to the formation of a hardened or cured coating.

The powder coating composition is preferably capable of forming coatings having average coating thicknesses of about 100 microns or less, or about 70 microns or less, or about 60 microns or less, or about 50 microns or less, or about 40 microns or less. During fabrication of a coated article and during use, the coating protects the underlying metal substrate, including the weld seam, from corrosion or other environmental conditions, thereby preserving the integrity of the container.

As discussed above, while not wishing to be bound by any theory, presently available evidence indicates that the metal-containing oxides in the coating react with and bind to sulfur-containing compounds such as, for example, hydrogen sulfide, in the pack that migrate into the coating from cysteine and other proteins in the food. In some examples, the coatings described herein are particularly useful for metal containers such as three-piece metal cans containing fish or meat. The metal-containing oxides react with the sulfur-containing compounds in the fish or meat and prevent the sulfur-containing compounds from corroding the interior metal surface of the container, particularly the side seam thereof.

The powder coating compositions of the present disclosure, powder coatings derived from the powder coating compositions, and methods for making them will now be further described in the following non-limiting examples.

### EXAMPLES

Materials
GRILTEX D 2343E, semi-crystalline polyester, EMS-Chemie AG, Domat, Switzerland, T_{g}=20° C., melting range=145-162° C., average melt viscosity=70 Pa-sec
GRILTEX V79-20, semi-crystalline polyester, EMS-Chemie, melting range 110-160° C.
GRILTEX D 2518E, semi-crystalline copolyester, EMS-Chemie, T_{g}=28° C., melting range=150-160° C., average melt viscosity=190 Pa-sec
GRILTEX D2338E, crystalline thermoplastic copolyester, EMS-Chemie, T_{g}=28° C., melting range=160-173° C., average melt viscosity=300 Pa-sec
DYNAPOL P1500, crystalline thermoplastic copolyester, Evonik Industries AG, Essen, DE, T_{g}=28° C., melting range=160-173° C., average melt viscosity=300 Pa-sec
GRILTEX D2141E, crystalline thermoplastic copolyester, EMS-Chemie, T_{g}=−20° C., melting range=142-152° C., average melt viscosity=120 Pa-sec
GRILTEX D2360E, amorphous copolyester, EMS-Chemie, T_{g}=70° C., average melt viscosity=240 Pa-sec
DYNAPOL EPS 1661, amorphous polyester, Evonik, T_{g}=70° C., average melt viscosity=240 Pa-sec
GMA-302 glycidyl methacrylate (GMA) copolymer, Estron Chemical, Calvert City, KY
BAYFERROX 3905, yellow pigment a synthetic iron hydroxide yellow pigment having the general formula α-FeOOH, Lanxess Deutschland GMBH, Köln, DE
SHIELDEX CS 311, synthetic silica pigment, Grace, Columbia, MD
BLANCFIXE NG, barium sulfate, Brenntag, N.V., Deerlijk, Belgium
ASP 400, aluminum silicate, BASF Kaolin, BASF Corp., Florham Park, NJ
ALMISIL C87, calcined clay, Biesterfeld AG, Hamburg, DE
BYK 366P, polyacrylate-based surface additive, BYK-Chemie GMBH, Wesel, DE

### Example 1

The materials listed in Table 1 below were blended and compounded with a twin screw extruder, then cryogenically milled to form a powder coating composition.

TABLE 1

| | Clear Standard 1 | |
|---|---|---|
| | (Comparative) | Bronze Coating 1 |
| Component | (wt %) | (wt %) |
| GRILTEX D 2343 | 55.00 | 55.00 |
| GRILTEX D 2360 | 18.00 | 18.00 |
| GMA-302 | 3.50 | 3.50 |
| BAYFERROX 3905 | | 0.50 |
| BLANCFIXE NG | 14.00 | 14.00 |
| ASP 400 | 8.00 | 8.00 |
| BYK 366 P | 1.50 | 1.00 |

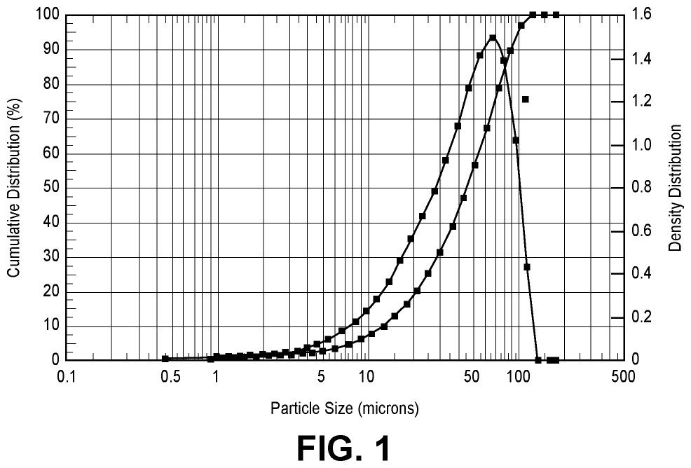

The powder coating particles were evaluated using a laser diffraction system available from Sympatec GmbH, Clausthal-Zellerfeld, DE. The system included a laser diffraction system available under the trade designation HELOS, as well as an automated dry dispersion unit available under the trade designation RODOS. A plot of the particle sizes in the powder coating is shown in FIG. 1.

### Example 2

The materials listed in Table 2 below were blended and compounded with a twin screw extruder, then cryogenically milled to form a powder coating composition.

TABLE 2

| | Clear Standard 2 | Clear Standard 3 | Bronze |
|---|---|---|---|
| | (Comparative) | (Comparative) | Coating 2 |
| Component | (wt %) | (wt %) | (wt %) |
| GRILTEX V79-20 | 73.00 | 73.00 | 73.00 |
| BAYFERROX | | | 0.50 |
| 3905 | | | |
| SHIELDEX CS | | 4.00 | |
| 311 | | | |
| BLANCFIXE NG | 18.00 | 14.00 | 18.00 |
| ASP 400 | 4.00 | 4.00 | 4.00 |
| ALMISIL C87 | 4.00 | 4.00 | 3.50 |
| BYK 366 P | 1.00 | 1.00 | 1.00 |

### Example 3

The materials listed in Table 3 below were blended and compounded with a twin screw extruder, then cryogenically milled to form a powder coating composition.

TABLE 3

| | Bronze Coating 3 |
|---|---|
| Component | (wt %) |
| DYNAPOL P 1500 | 45-60 |
| DYNAPOL EP S | 10-15 |
| 1661 | |
| GMA-302 | 2-3 |
| BAYFERROX 3905 | 0.5-4 |
| BLANCFIXE NG | 10-20 |
| ASP 400 | 5-10 |
| BYK 366 P | 1-2 |

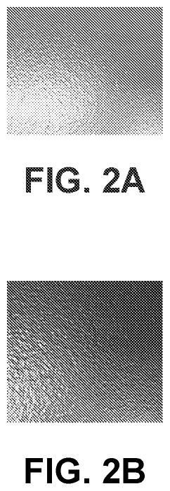

Bronze powder coatings 1-3 were applied on metal panels and melted to form a powder coating with a gold appearance (FIG. 2A). The gold powder coatings were heated in a sulfuric acid solution for about 1 hour at 121° C., and the gold coatings turned a deep black, which indicated the presence of iron sulfide and, thus, scavenging of sulfur compounds by the BAYFERROX iron hydroxide (FIG. 2B). The powder coatings had excellent powder adhesion after retort, as well as excellent pack resistance over time.

Various embodiments of the invention have been described. These and other embodiments are within the scope of the following claims.

1. A coating composition comprising:
about 50 wt % to 99 wt % of at least one thermoplastic polyester resin having a weight-average molecular weight (M_{w}) of about 15,000 to about 60,000; and
about 0.5 wt % to about 5 wt % of at least one metal-containing oxide chosen from iron oxides, zinc oxides, and mixtures and combinations thereof; and
wherein the coating composition is meltable to form a coating on at least one portion of a substrate formed into a side seam of a container.

2. The coating composition of claim 1, wherein the coating composition is in the form of a powder having less than about 10 wt %, if any, of an inhalable fraction with a particle size of less than about 1 micron.

3. (canceled)

4. (canceled)

5. The coating composition of claim 1, wherein the metal-containing oxide comprises an iron oxide and wherein the iron oxide is chosen from FeOOH, Fe₂O₃, Fe₃O₄, FeO, Fe₂O₃·nH₂O, FeCO₃, Fe₂(CO₃)₂, and mixtures and combinations thereof.

6. (canceled)

7. The coating composition of claim 1, wherein the polyester resin has a melting temperature of about 140° C. to about 180° C. and/or a glass transition temperature of about −10° C. to about 45° C.

8. (canceled)

9. The coating composition of claim 1, wherein
the polyester resin is a semicrystalline thermoplastic polyester derived from ingredients including a dicarboxylic acid chosen from isophthalic acid, terephthalic acid, adipic acid, and mixtures and combinations thereof, and a diol chosen from butane diol or ethylene glycol.

10. The coating composition of claim 1, further comprising from about 1 wt % to about 5 wt % of a polymer derived from a glycidyl ester of (meth)acrylic acid.

11. (canceled)

12. (canceled)

13. The coating composition of claim 1, further comprising a second polyester resin different from the polyester resin and wherein the second polyester resin is an amorphous polyester resin with a glass transition temperature of about 20° C. to about 70° C.

14. (canceled)

15. The coating composition of claim 1, wherein the coating composition is substantially free of TiO₂.

16. (canceled)

17. The coating composition of claim 1, further comprising a second resin chosen from epoxy resins, acrylic resins, and mixtures and combinations thereof.

18. (canceled)

19. A method for forming a coating on a side seam of a metal container, the method comprising:
applying to a substrate a coating composition comprising:
about 50 wt % to 99 wt % of at least one thermoplastic polyester resin having a weight-average molecular weight (M_{w}) of about 15,000 to about 60,000; and
about 0.5 wt % to about 5 wt % of a metal-containing oxide reactable with sulfide-containing compounds; and
melting the coating composition to form a coating on at least one portion of the substrate, wherein the substrate is a side seam of the metal container or is formed into a side seam of a metal container.

20. The method of claim 19, wherein the coating composition is in the form of a powder having less than about 10% wt %, if any, of an inhalable fraction with a particle size of less than about 1 micron.

21. (canceled)

22. (canceled)

23. (canceled)

24. The method of claim 19, wherein the metal-containing oxide is chosen from iron oxides, zinc oxides, and mixtures and combinations thereof.

25. (canceled)

26. (canceled)

27. (canceled)

28. The method of claim 19, wherein the coating composition further comprises about 1 wt % to about 5 wt % of polymer derived from glycidyl methacrylate.

29. (canceled)

30. (canceled)

31. (canceled)

32. (canceled)

33. (canceled)

34. A metal container comprising a side seam, and a coating formed on the side seam, wherein the coating has an average coating thickness of about 40 microns to about 100 microns, and wherein the coating is formed from a coating composition comprising: about 50 wt % to 99 wt % of at least one thermoplastic polyester resin having a weight-average molecular weight (M_{w}) of about 15,000 to about 60,000; and about 0.5 wt % to about 5 wt % of a metal-containing oxide reactable with sulfide containing compounds.

35. The container of claim 34, wherein the coating composition is in the form of a powder having less than about 10 wt %, if any, of an inhalable fraction with a particle size of less than about 1 micron.

36. (canceled)

37. The container of claim 34, wherein the metal-containing oxide is an iron oxide chosen from FeOOH, Fe₂O₃, Fe₃O₄, FeO, Fe₂O₃·nH₂O, FeCO₃, Fe₂(CO₃)₂, and mixtures and combinations thereof.

38. The container of claim 34, wherein the polyester resin has a melting point of about 140° C. to about 180° C. and a glass transition temperature of about −10° C. to about 45° C.

39. The container of claim 34, wherein the coating composition further comprises about 1 wt % to about 5 wt % of a highly functional resin component comprising a glycidyl ester of (meth)acrylic acid.

40. (canceled)

41. The container of claim 34, wherein the coating composition further comprises a second polyester resin different from the polyester resin, the second polyester resin comprising an amorphous polyester resin with a glass transition temperature of about 20° C. to about 70° C.; and/or wherein the coating composition further comprises a second resin chosen from epoxy resins, acrylic resins, and mixtures and combinations thereof.

42. (canceled)

43. (canceled)

44. (canceled)

45. The container of claim 34, wherein the container contains a food or beverage product, and wherein the coating is in contact with the food or beverage product.
